(19) United States
(12) Patent Application Publication
(10) Pub. No.: US 2014/0134430 A1
(43) Pub. Date: May 15, 2014

(54) LABEL FACESTOCK

(71) Applicant: UPM RAFLATAC OY, Tampere (FI)

(72) Inventors: Noel MITCHELL, Wuppertal (DE); Matti Manner, Tampere (FI)

(73) Assignee: UPM RAFLATAC OY, Tampere (FI)

(21) Appl. No.: 14/075,865

(22) Filed: Nov. 8, 2013

Related U.S. Application Data
(60) Provisional application No. 61/724,336, filed on Nov. 9, 2012.

(30) Foreign Application Priority Data
Nov. 9, 2012 (FI) 20126174

(51) Int. Cl. G09F 3/10; C08L 45/00; C08L 23/06

(52) U.S. Cl. CPC G09F 3/10; C08L 23/06; C08L 45/00
USPC 428/354; 525/216; 428/516; 428/523

(57) ABSTRACT

A machine direction oriented multilayer facestock for labels. The facestock includes a skin layer including at least polyethylene and cyclic olefin copolymer(s). The facestock is annealed. Also a use of the multilayer facestock for self-adhesive labels and to a self-adhesive label including the multilayer facestock.

### CROSS-REFERENCE TO RELATED APPLICATIONS

This application claims priority to U.S. provisional patent application 61/724,336 filed 9 Nov. 2012 and Finnish patent application 20126174 tiled 9 Nov. 2012.

### FIELD OF THE INVENTION

The application relates to labels. More particularly, the invention relates to a machine direction oriented multilayer facestock, and to a self-adhesive label comprising a machine direction oriented multilayer facestock.

### BACKGROUND OF THE INVENTION

It is general practice to apply a label to a surface of an item to provide decoration, and/or to display information about the product being sold, such as the content of the item, a trade name or logo.

### SUMMARY OF THE INVENTION

It is an object of this application to provide plastic film for labels. It is an object to provide a facestock of a label which provides adequate properties for labelling applications.

According to a first aspect of the invention a machine direction oriented multilayer facestock for labels is provided. The facestock comprises a core layer having a first surface and a second surface, and a first skin layer adjoined to the first surface of the core layer. The first skin layer of the facestock may comprise at least polyethylene and cyclic olefin copolymer(s). Further, the facestock is annealed.

According to a second aspect of the invention a use of a machine direction oriented multilayer facestock for self-adhesive labels is provided.

According to a third aspect of the invention a self-adhesive label comprising an adhesive layer and a machine direction oriented multilayer facestock is provided. The multilayer facestock may comprise at least a core layer having a first surface and a second surface, a first skin layer adjoined to the first surface of the core layer and the adhesive layer adjoined to the second surface of the core layer. The first skin layer may comprise at least polyethylene and cyclic olefin copolymer(s). Further, the facestock may be annealed.

According to a fourth aspect of the invention a combination of an item and a label is provided. The label may comprise an adhesive layer and a machine direction oriented multilayer facestock. The facestock may comprise at least a core layer having a first surface and a second surface, a first skin layer adjoined to the first surface of the core layer and the adhesive layer adjoined to the second surface of the core layer. The first skin layer may comprise at least polyethylene and cyclic olefin copolymer(s). Further, the facestock may be annealed.

Further embodiments of the invention are presented in the dependent claims.

The polyethylene of the first skin layer of the facestock may be linear low density polyethylene. The linear low density polyethylene may be Ziegler-Natta catalysed.

The first skin layer of the facestock may comprise between 10 and 90 wt. % linear low density polyethylene and between 10 and 70 wt. % cyclic olefin copolymer(s).

The core layer of the facestock may comprise at least one of the following: propylene homopolymer, block-copolymer and random copolymer; and at least one of the following polyolefin elastomer and polyolefin plastomer. In addition, if any, the core layer may comprise low density polyethylene.

The core layer of the facestock may comprise polyolefin plastomer and/or polyolefin elastomer, which are based on copolymers of ethylene or propylene with hexene, octene or butylene.

In addition, the facestock may comprise a second skin layer adjoined to the second surface of the core layer.

### DESCRIPTION OF THE DRAWINGS

In the following examples, the embodiments of the invention will be described in more detail with reference to appended drawings, in which

FIG. 1 shows, in a cross-sectional view, a laminated structure for labels,

FIG. 2 shows, in a cross-sectional view, a laminated structure comprising die-cut labels,

FIG. 3 shows, in a cross-sectional view, separating a release from a label,

FIG. 4 shows, in a cross-sectional view, a multilayer facestock structure,

FIG. 5 show, in a side view, example of a conformable facestock,

FIG. 6 shows, in a side view, example of a conformable facestock,

FIG. 7 shows, in a side view, a label attached to a surface of an item.

### DETAILED DESCRIPTION OF THE INVENTION

In this description and claims, the percentage values are percentages by weight (wt. %) unless otherwise indicated. The term “conformability” refers to the capability of the label to conform smoothly to the contour of the article even when this is curved in two dimensions. The term “dualistic asymmetric” or “double asymmetric” refers to a multilayer facestock having both different layer thickness and composition of separate layers. The term “clear facestock” refers to a facestock being transparent to visible light, which further allows the objects beneath such facestock to be visible through the facestock.

The following reference numbers and denotations are used in this application:

D5 thickness of a first skin layer,
D6 thickness of a core layer,
D7 thickness of a second skin layer,
Sₓ, S_{y}, S_{z} orthogonal directions,
1 a laminate web,
3 a label,
100 a facestock,
101 a core layer,
105 a second skin layer,
110 a first skin layer,
112 a printing layer,
114 an adhesive layer,
115 a release liner,
118 a protective layer,
310 an item.

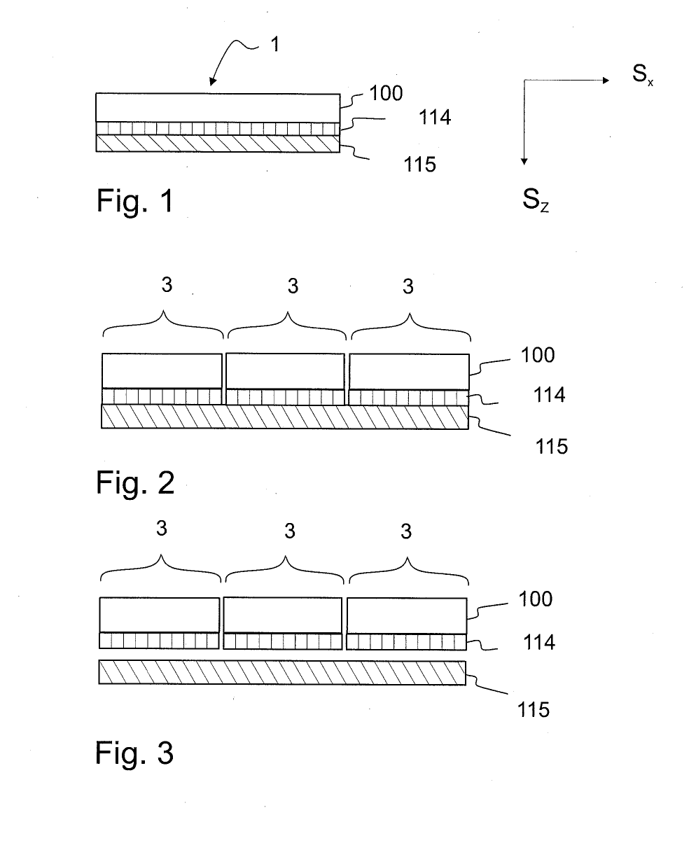

With reference to FIG. 1, a laminate web 1 for labels, also referred to as a label laminate or a labelstock, comprises at least a facestock 100. In addition it may comprise an adhesive layer 114. Additionally it may include a release liner 115. In a laminate structure having a release liner, the adhesive layer 114 is between the facestock layer 100 and the release liner 115. The facestock may also be referred to as a face material layer, a face layer or a face film. The liner is mainly used to protect the adhesive layer. It also allows efficient handling of the label up to the point where the label is dispensed from the liner and adhered to a substrate surface. The liner 115 includes a backing material, such as a plastic film or paper substrate, coated with a thin layer of release agent, such as silicone. Therefore, the release liner 115 can be easily removed from the adhesive layer of the label prior to labelling, i.e. before adhering the label to a substrate. The plastic backing material of the release liner may be, for example, a polyester film, a biaxially or machine direction oriented polypropylene film. The thickness of the plastic liner is preferably 20 to 30 microns or even less than 20 microns. Paper substrates may have a thickness between 40 and 60 microns.

Referring to FIG. 2, individual labels 3 may be cut from the laminate web 1. In particular, the labels 3 may be die-cut from the web 1. After the cutting, the labels may be attached to a common liner 115, which remains uncut. Thus, a plurality of labels may remain attached to a common continuous liner 115. Alternatively, the labels 3 may be completely separate, i.e. also the liner 115 may be cut. Referring to FIG. 3, the labels 3 may be separated from the liner 115 e.g. by pulling the liner 115 in the direction S_{z} with respect to the label 3. Thus, a surface of the adhesive layer 114 may be exposed so that said surface can be attached to an item.

Thanks to the adhesive layer 114 the label can be affixed to the substrate, i.e. to the surface of an item (article), such as a surface of a bottle. The adhesive layer may consist of a pressure sensitive adhesive (PSA). The labels consisting of PSA can be adhered to most surfaces through an adhesive layer without the use of a secondary agent, such as a solvent, or heat to strengthen the bond. The PSA forms a bond when pressure is applied onto the label at room temperature, adhering the label to the product to be labelled. The label comprising pressure sensitive adhesive may be referred to as a pressure sensitive adhesive (PSA) label. Pressure sensitive adhesive labels may also be referred to as a self-adhesive labels.

In the following description a label is preferably a self-adhesive label, wherein the label may be used in labelling of articles, such as glass or plastic bottles, packages, or other containers. Also paper or metal based articles may be labelled. The label is suitable for labelling of e.g. home and personal care products, industrial chemical products, pharmaceutical and health care products, beverage and wine bottles, tyres etc. Self-adhesive labels are made from a self-adhesive labelstock (self-adhesive label laminate). The self-adhesive label may comprise a facestock and an activatable adhesive layer. Alternatively, the self-adhesive label may comprise a facestock, a pressure sensitive adhesive (PSA) layer and a release liner, which normally includes silicone. The release liner is removed from the self-adhesive label prior to labelling. In other words, the self-adhesive label may be adhered to the article through an adhesive layer, which adhesive may be either activatable or pressure-sensitive adhesive. Accordingly, the facestock of the self-adhesive label may be laminated with a release liner having a PSA layer in between, or the self-adhesive label may be a linerless facestock including a facestock and an activatable adhesive layer. Thus, a facestock for a self-adhesive labelstock use, also referred to as a label laminate, is provided. Further, a facestock for a self-adhesive label use is provided.

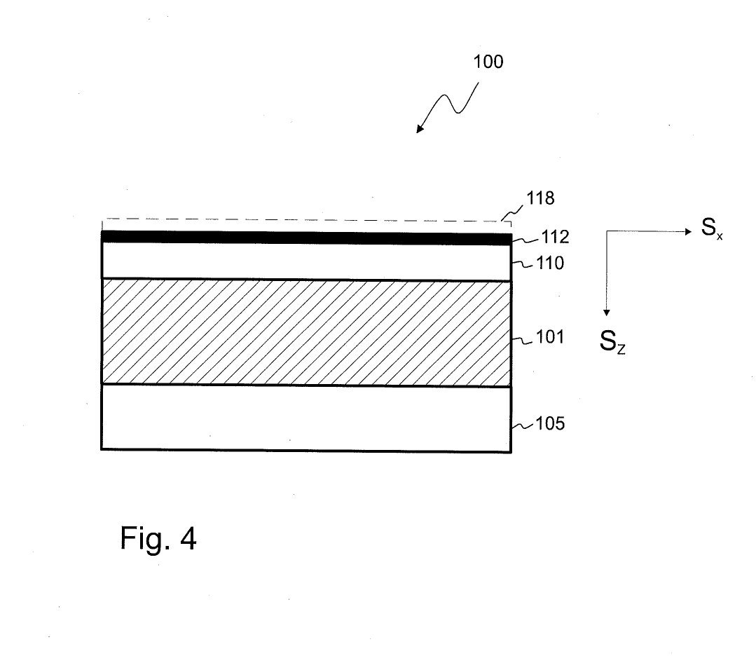

Graphical patterns may be printed on the facestock layer 100 e.g. in order to provide a visual effect and/or in order to display information. The printing may be performed to a facestock layer 100 prior to lamination of a laminate web 1 for labels. Alternatively, a facestock 100 of a laminated structure 1 is printed. A laminate or label consisting of a facestock layer and printing layer may be referred to as a printed laminate or printed label. With reference to FIG. 4, the printing layer 112 may be on top of the facestock 100. The laminate may also include a protective layer(s) 118 (overlaminate layer(s)), such as lacquer, on top of the printing layer 112.

For allowing processing in usual labelling devices and lines, the facestock 110 layer should have sufficient mechanical properties. For example, the facestock layer should have sufficient modulus and stiffness values in order to provide die-cuttability for the label. From the economical point of view, the smallest possible thickness of the facestock is also preferred. In order to optimize the facestock properties the facestock may have a multilayer structure. The multilayer structure may be symmetric. Alternatively, it may be asymmetric. For example, asymmetric structure of the facestock layer may be preferred when optimizing facestock parameters suitable for labels, for example transparency and stiffness. The separate plastic layers in the multilayer facestock structure, e.g. a three layer structure, may have different formulations. For example, skin layers may have a different composition when compared to the composition of the core layer. Asymmetry of the multilayer facestock layers may be achieved by using different film compositions of the layers or by varying the thickness of the layers. If the facestock layers have both a different composition and a different thickness, the structure of the multilayer facestock may be called double asymmetric.

With reference to FIG. 4, the facestock layer 100 may have a multilayer plastic film structure including two or more plastic film layers. The multilayer facestock, also referred to as to a multilayer film, may comprise a core layer and at least one skin layer. The facestock may have a skin layer on both surfaces of the core layer, i.e. the facestock may have a three layer structure. The facestock 100 may have a core layer 101 including a first surface and a second surface, wherein the first skin layer 110 is provided on the first surface of the core layer 101. The second skin layer 105 is provided on the second surface of the core layer 101. The first skin layer may also be referred to as the print receiving layer and the second skin layer as the adhesive receiving layer. Alternatively, the facestock may include only a core layer 101 and one skin layer. For example, in a two layer structure the face stock comprises a core layer and a first skin layer. In a two layer structure, the adhesive layer may be applied directly to the second surface of the core layer opposite to first skin layer.

There may also be additional skin layers or other layers, such as barrier and/or tie layers, in order to improve the label features, such as label functionality, mechanical properties, or the visual appearance. A tie layer may be used in order to provide enhanced adhesion between the core and skin layer(s) and prevent peeling (delamination) of the multilayer structure. Barrier layer(s) may be used in order to prevent, for example, migration of unwanted ingredients. An over-vanish or lacquer layer may be used on top of the print layer to protect the printing layer. Film surfaces may also be treated prior to printing, for example by flame treatment, corona treatment or plasma treatment in order to enhance for example adhesion of the printing. Treated surfaces may also be top coated.

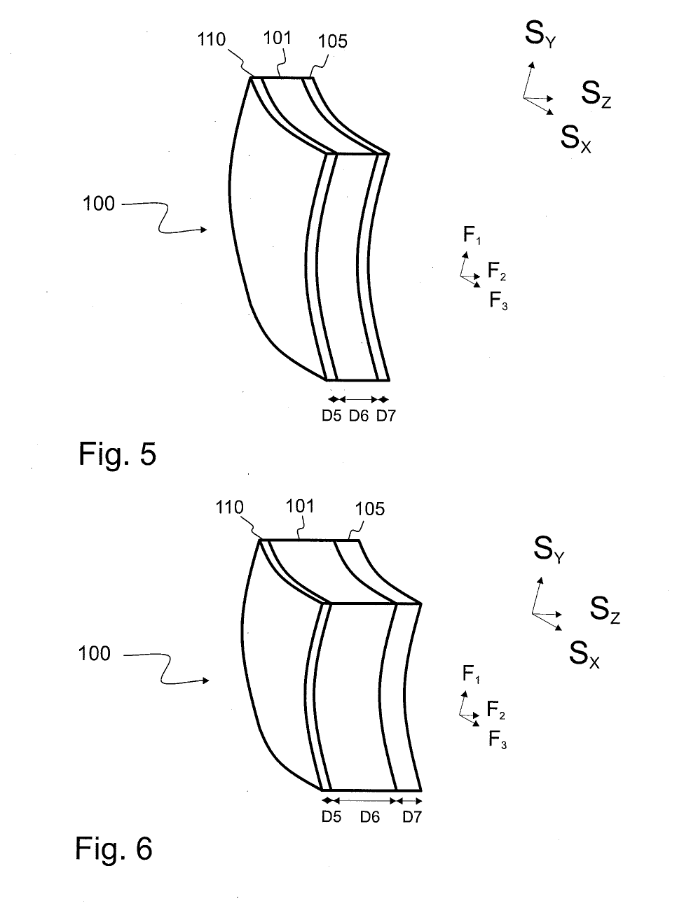

In a multilayer structure, the thicknesses of separate layers may be different. Preferably, the core layer may be relatively thick compared to skin layer(s). In other words, the thickness of the core layer may be greater than the thickness of the first skin layer and/or the second skin layer. The thickness for the three layered film (1st skin %:core %:2nd skin %=total100%), as shown in FIG. 5, may be 5:85:10 or 5:90:5. In other words, if an asymmetric facestock structure is preferred, the thicknesses of individual layers may be different from each other.

For example, the thickness of the core layer may be between 60 and 90%, or between 70 and 90%, preferably between 75 and 90% or between 80 and 90% of the total thickness of the facestock layer. The thickness of the first skin layer may be at least 2% or at least 5%, between 2 and 10% or between 5 and 10% of the total thickness of the facestock. The thickness of the second skin layer, if any, may be at least 2% or at least 5%, between 2 and 30% or between 5 and 10% of the total thickness of the facestock layer. A thin first skin layer may be preferred in order to control the haze of the facestock film. The thin skin layer is advantageous if a transparent facestock should be provided. Thanks to the thick core layer, adequate mechanical properties of the facestock for labels may be achieved. For example, a MDO multilayer facestock may have a tensile modulus ratio of the machine direction to the transversal direction of the facestock between 2.0 and 3.8.

Preferably, the facestock 110 of the label has a total thickness smaller than 100 microns or smaller than 80 microns, preferably smaller than 60 microns. The facestock layer may have a total thickness between 30 and 80 microns, or between 40 and 60 microns, for example 50 microns. The thickness of the first skin layer may be at least 1 μm or at least 2 μm. The thickness of the first skin layer is preferably smaller than 5 μm. The thickness of the first skin layer may be between 1 and 5 microns, preferably between 1.5 and 3 microns. The core layer may have a thickness of 30 to 50 microns, preferably 35 to 45 microns, for example, 43 microns. The second skin layer may have a thickness of at least 1 μm or 2 μm. The thickness of the first skin layer is preferably smaller than 10 μm, or smaller than 8 μm. The second skin layer may have a thickness between 1 and 10 microns, preferably between 2 and 6 microns.

If clear facestocks are preferred, the haze of the facestock may be less than less than 30%, and most preferably equal to or less than 25% when measured according to the standard ASTM D1003. In addition, the haze may be at least 1% or 10%. The haze of a clear facestock may be, for example, between 1 and 30%, or between 2 and 25%.

Alternatively, opaque and/or white facestocks may be provided. Therefore, the facestock may comprise one or more pigments or inorganic fillers as an additive to provide the facestock with a desired colour. Additives may include, for example, titanium dioxide, calcium carbonate and blends thereof. Carbon black may be introduced to provide a black or grey facestock. Opaque facestocks may have an opacity of at least 70%, at least 75%, or at least 80%, for example between 70 and 95% or between 70 and 80%. In a multilayer facestock structure the pigment may be included in only one layer. The pigment may be included, for example, in the core layer. Alternatively, the pigment may be also in other layers.

In the multilayer structure the compositions of different layers should be at least partially compatible with each other. For example, at least some of the polymer components in the skin layers should be compatible with the polymer(s) of the core layer to provide sufficient adhesion to the core layer without additional intermediate tie layer(s). In addition, a blocking tendency of the facestock, when the facestock is rolled on itself, may be reduced by using different film compositions in the first and second skin layers of the multilayer structure. For example, an antiblocking agent may be used in a conventional manner in at least one skin layer creating some surface roughness in order to assist the unwinding of the facestock roll. In addition to this, the surface roughness of the skin layer(s) created by using the antiblocking agent may also be advantageous during stretching of the film. Thanks to the surface roughness the surface friction between the skin layer and the drawing roll may be adjusted. Also the blocking tendency of the skin layer(s) onto the drawing rolls may be avoided. The antiblocking agent may be used on at least the adhesive receiving skin layer.

Thanks to the specific multilayer structure and composition of the layers, thin and low cost films with properties suitable for the labelling applications may be manufactured. For example, MDO films having a double asymmetric structure may allow conformability of the label during the application of the label (labelling). Also, thin labels having adequate and predetermined stiffness during die-cutting and dispensing may be achieved. In addition, the films are suitable for printing, recycling and they may be used as a substrate for different types of adhesives. The multilayer structures and layer compositions are presented below.

The core layer of the facestock includes a major amount of polymeric ingredients, i.e. it may be based on a polymer blend. It may also comprise a minor amount of non-polymeric additives. Percentages of separate polymers in the core layer are percentages by weight based on the total polymer weight of the layer. Preferably, the core layer has a specific polymer blend composition providing sufficient stiffness for the facestock film. The core layer composition also affects the die-cutting performance of the label. In addition, it should enable the conformability of the label.

According to an embodiment, the core layer may comprise or consists of a polymer blend including propylene homopolymer (homo PP), low density polyethylene (LDPE), hydrocarbon resin (HO) and styrene block copolymer. In addition, the core layer may contain minor components.

According to an embodiment, the core layer may comprise or consists of a polymer blend including mainly of propylene polymer. Propylene polymer may be at least one of the following: propylene homopolymer (homo PP), propylene block copolymer and propylene random copolymer. The core may comprise at least one of the following: polyolefin elastomer(s) and polyolefin plastomer(s). Thanks to the elastomer(s)/plastomer(s) the flexibility of the film in the transverse direction (TD) may be increased. Suitable elastomers and plastomers may be based on copolymers of ethylene or propylene with hexene, octene or butylene (1-butene). For example butene based ethylene alpha olefin plastomers may be used, such as Exact 3024, 4011 and/or 4049. Alternatively, or in addition, octane based plastomers may be used, such as Exact 0203, 0210, 0230, 8203, 8210 and/or 8230. Densities of plastomers may range from 0.86 to 0.91 kg/m³. Propylene based elastomers include, for example, Vistamaxx range from Exxon Mobil, such as Vistamaxx L330, 3020FL or 3980FL. Propylene based plastomers may include Koattro range of butylene (1-butene) based copolymers from LyondellBasell. For example, Koattro KTAR 05. The total content of plastomer(s) and/or elastomer(s) may be between 5 and 35% or between 15 and 25%. For example, the core may include 5%, 10%, 15%, 20%, 25%, 30% or 35% of plastomer(s) and/or elastomer(s). The content of plastomer(s) and/or elastomer(s) may be at least 2 or 3%, preferably at least 5, 10 or 15%. The content of plastomer(s) and/or elastomer(s) may be at most 20, 25 or 35%. In addition, the core layer may comprise low density polyethylene (LDPE). The content of LDPE may be 3 to 20%. The content of LDPE may be e.g. 3, 5, 10, 15 or 20%. Thanks to the low density polyethylene the overall stability of the film may be increased. In addition, the core may comprise cyclic olefin copolymer(s) e.g. 5 to 10%. COC in a core layer may provide a better adhesion between the skin and core layers of the multilayer structure. In addition, the core layer may contain minor components.

The main polymer in a core layer may be a propylene homopolymer. Propylene homopolymers are polymers of propylene only, i.e. all the repeating units along a chain are of the same type. The polypropylene is preferably isotactic, wherein all of the methyl side groups are located on the same side of the polymer chain. In addition, PP may have melt flow rates (MFR) from 2 to 12, as determined by specially designed MFR apparatus. Useful propylene homopolymers may also be characterized as having densities in the range of 0.89 to 0.91 kg/m³. The propylene homopolymer is preferred in the multilayer film structure due to the specific stiffness needed for the film.

According to an embodiment, in the core layer the content of propylene homopolymer (homo PP) may be at least 40%, preferably at least 50%, more preferably at least 60%, at least 70% or at least 80%. Preferably the content of homo PP is not more than 95% or not more than 90%. The content of polypropylene may be between 40 and 90% or between 50 and 80%. As an example, the core layer may comprise 60%, 65%, 70%, 75% or 80% of propylene homopolymer.

According to an embodiment, the total content of propylene polymer(s) (homopolymer and/or copolymer(s)) in the core layer may be at least 60%, at least 80% or at least 95%. For example, between 40 and 98% or between 50 and 95%.

Polyethylene which can be utilized in the core layer of the facestock may be a low density polyethylene (LDPE). Low density polyethylene is a branched, semicrystalline thermoplastic polymer. LDPE may have a density between 0.910 and 0.933 g/cm³, preferably between 0.910 and 0.925 g/cm³.

According to an embodiment, the content of LDPE may be at least 1′)/0 or 2%, preferably at least 3%. The content of LDPE is not more than 20% or 10%, preferably not more than 8%. For example, the LDPE content may be between 1 and 20%, preferably between 3 and 10%, or between 3 and 8%. The amount of LDPE may be 3%, 4% 5%, 6%, 7% or 8%. LDPE is used, for example, in order to stabilize the facestock during manufacturing, thus improving the processability of the facestock. It may also be beneficial when improving the adhesion between the layers in multi-layered facestock structure. However, long branches of the LDPE can make the orientation more complex and the content of LDPE is preferably less than 10%, or less than 5%, for example between 0 and 5%.

According to an embodiment, in order to increase the stiffness of the facestock the core layer may contain hydrocarbon resin(s). It may also be beneficial in improving the clarity of the facestock. Hydrocarbon resins are low molecular weight compounds (polymers/oligomers) consisting of only hydrogen and carbon. Hydrocarbon resins may have amorphous structure and they may be derived from synthetic or natural monomers. For example, petroleum based resins may be used. Hydrocarbon resins may be partially or fully hydrogenated. Saturated hydrocarbons are composed entirely of single bonds and are saturated with hydrogen (fully hydrogenated). The hydrocarbon resin may be aromatic, i.e. having at least one aromatic ring. Alternatively, it may be an acyclic or cyclic aliphatic resin. The number average molecular weight (Mn) of the HC may be below 2000 g/mol. For example, the Mn may be between 400 and 500 g/mol and the Mw (weight average molecular weight) between 600 and 700 g/mol, when measured via gel permeation chromatography using PS standards. The softening point according to ASTM E 28 may be below 140° C., preferably between 90 and 140° C. In a core layer the content of hydrocarbon resin is at least 1% or 3%, preferably at least 6 or 9%. The content of HC is at most 18% or 15%, preferably at most 12% or 10%. The HC content of the core layer may be between 5 and 20%, preferably between 8 and 12%. For example, the content of HC may be 5%, 8% 9%, 10% or 12%. The hydrocarbon resin may be added during the manufacturing process of a film as a compound consisting of HC resin and a suitable carrier, such as thermoplastic olefin polymer. The carrier may be for example, propylene homopolymer.

According to an embodiment, the core layer may include styrene block copolymer(s). Styrene block copolymers include, for example, styrene-ethylene-propylene-styrene (SEPS), styrene-ethylene-butylene-styrene (SEBS), styrene-ethylene-propylene block copolymer (SEP) and styrene-ethylene-ethylene-propylene-styrene block copolymer (SEEPS). Preferably styrene-ethylene-propylene-styrene (SEPS) is used. Optionally, styrene-ethylene-butylene-styrene (SEBS) may be used. It is also possible to use mixtures of styrene block copolymers, such as mixtures of SEBS and SEPS. The content of styrene block copolymer is at least 1% or 5%, preferably at least 9%. The core layer contains at most 20% or 17%, preferably at most 15% styrene block copolymer. The content may be between 5 and 20%, preferably between 8 and 15%, for example 5%, 8%, 12% or 15%. Preferably, styrene block copolymer, such as SEPS, is used in order to decrease stiffness and to increase the flexibility of the film thus enhancing the conformability of the film. In other words, the label material flexible enough is able to conform with the surface of the item labelled, i.e. the label accommodates with the underlying contour without wrinkles. SEPS may also be advantageous for increasing the tear resistance of the film in machine direction.

In addition, the core layer may comprise minor components, such as 1% of an antioxidant for preventing gel formation due to the oxidation during extrusion process of the film. The antioxidant may also be effective in maintaining the mechanical properties of the film. Other minor components include, for example, an antiblocking agent and linear low density polyethylene. Thanks to the LLDPE the adhesion between the core layer and skin layer(s) may be improved. The amount of the antiblocking agent in the core layer may be lower than 1000 ppm, or lower than 500 ppm, preferably lower than 100 ppm, for example, 60 ppm, between 20 and 500 ppm, or between 60 and 100 ppm by weight of the total weight of the layer. The amount of LLDPE may be at most 20%, or at most 10%, for example, between 0.1 and 20% or between 0.1 and 3% by weight based on the total polymer weight of the layer. In the core layer, virgin based raw materials may be used, or the raw materials may comprise recycled raw material. For example, the recycled raw material may be from the facestock manufacturing process.

The first skin layer of the multilayer facestock structure should be suitable for printing and provide a sufficient printing ink anchorage. For example, flexographic printing may be used. Printing ink may include, for example water-based flexographic inks. The first skin layer should also provide good adhesion to the core layer in order to avoid peeling or delamination of the multilayer facestock structure. The first skin layer has a plastic structure including a major amount of polymer ingredients and minor amount of non-polymeric additives. Preferably, the first skin layer includes linear low density polyethylene (LLDPE). In addition, it includes cyclic olefin copolymer. Minor components of the first skin layer include, for example, an antiblocking agent (AB), such as synthetic silica. The antiblocking agent may be added during film manufacturing as a compound comprising silica blended with a carrier, such as polyethylene. For example, the compound may contain 10% synthetic silica and 90% polyethylene. The content of the antiblocking compound may be for example 1%, 2% or 3% based on the weight of the first skin layer. In the first skin layer, the content of the antiblocking agent is at least 0.05%, preferably at least 0.1 or 0.2%. The antiblocking agent content is at most 4%, preferably at most 1 or 0.5%. For example, the content is between 0.05 and 0.2%, between 0.2 and 0.5, or between 1 and 4%. Higher contents, e.g. 1 to 4%, are used if matte films are preferred. For achieving an antislipping and/or antiblocking effect for the film, lower contents may be used, for example between 0.05 and 0.5%, 0.05% 0.1%, 0.15, 0.3, 0.3% based on the weight of the first skin layer.

The main polymer of the first skin layer is a linear low density polyethylene (LLDPE). LLDPE is a substantially linear polymer with short branches. LLDPE may be produced by using a Ziegler-Natta catalyst, in order to provide LLDPE not being a polyethylene elastomer. Optionally, LLDPE may be produced using metallocene catalyst (m-LLDPE). Thanks to the linear polymer chain structure, the LLDPE is suitable for orientation (stretching). The content of LLDPE may be at least 10%, at least 20% or at least 30% based on the weight of the first skin layer. The content of LLDPE may be at most 90%, or at most 80 or at most 70%. For example, the content of LLDPE may be 40, 50, 60, 70, 80 or 90% The skin layer may contain between 10 and 90%, or between 20 and 80%, or between 40 and 80% linear low density polyethylene. For example, Dowlex 2108G from Dow Chemical may be used. Thanks to the LLDPE, the first skin layer is more suitable for subsequent surface treatment of the film by e.g. corona, plasma or flame treatment.

In addition, the first skin layer includes cyclic olefin copolymer(s) (COC). These polymers are amorphous, transparent copolymers based on polymerisation of ethylene and norbornene. For example, Topas 8007-400, 6013F-04, 9506F-500 or 5013F-04 from Topas Advanced Polymers may be used. The content of cyclic olefin copolymer(s) is at most 70%, or at most 60%, or at most 50%. The content of cyclic olefin copolymer(s) is at least 5%, at least 10%, at least 15% or at least 20%. The skin layer may contain between 10 and 70% or between 20 and 50% COO. Thanks to the cyclic olefin copolymers the films having high transparency and gloss combined with high stiffness and strength may be achieved. Due to the inclusion of an intrinsically harder COO to the skin layer composition comprising linear low density polyethylene, the flexibility in the cross direction S_{y} of the film may be improved. Further, the composition comprising LLDPE and COO may provide films having adequate stiffness in the machine direction Sₓ. Thanks to the improved flexibility the film possess excellent conformability and squeezability when used in pressure-sensitive label applications. Squeezability refers to the property of a label not to lift or wrinkle during squeezing of the item on to the label is applied. In addition, the specific skin layer composition comprising LLDPE and cyclic olefin copolymers has a positive impact on the printability of the first skin layer.

Further, a label laminate structure may comprise a second skin layer. In the label laminate structure, the second skin layer of the multilayer facestock is the adhesive receiving layer. Thus, the composition of the layer should provide a surface for an adhesive layer to be joined, said surface being capable of providing good anchorage of an adhesive. It should also provide good adhesion to the core layer in order to avoid peeling or delamination of the multilayer facestock structure. The second skin layer may include all the same polymeric ingredients as the core layer presented above.

According to an embodiment, the second skin layer may include propylene homopolymer, propylene block-copolymer or random copolymer, polyolefin elastomer(s) and/or plastomer(s), and low density polyethylene (LDPE). LDPE may be used in order to provide better adhesion to the core layer. The second skin layer composition may further include linear low density polyethylene (LLDPE). Thanks to the LLDPE the machine processability and adhesive anchorage may be increased. The content of LLDPE may be at most 30%, at most 20% or at most 10%. The content of LLDPE may at least 5%. For example, the content may be between 5 and 30%, or between 10 and 25%.

According to an embodiment, the content of linear low density polyethylene in the second skin layer may be between 0 and 50% or between 20 and 40% of the content of linear low density polyethylene in the first skin layer.

According to an embodiment, the second skin may also comprise components, such as at least one of the following, hydrocarbon resin or styrene block copolymer, which are not included in the first skin layer composition.

In addition, the second skin may comprise an antiblocking agent, such as silica. The content of the antiblocking agent may be e.g. 0.2%. The antiblocking agent is preferably the same as used in the first skin layer and presented above. The content of the antiblocking agent is at least 0.05%, preferably at least 0.1 or 0.2%. The AB content is at most 4%, preferably at most 0.5%. For example, the content is between 0.05 and 0.2%, between 0.2 and 0.5, or between 1 and 4%.

In addition, all polymeric layers in the multilayer structure may further comprise minor components, such as inorganic fillers, pigments, other organic or inorganic additives in order to provide desired properties, such as appearance (opaque or coloured films), durability and processing characteristics. Examples of useful minor components include calcium carbonate, titanium dioxide, antioxidant compounds, optical brighteners, antistatic aids and processing aids.

In an asymmetric multilayer facestock structure the thickness of the first skin layer may be different from the thickness of the second skin layer. For example, the thickness of the first skin layer is between 10 and 90% of the thickness of the second skin layer. Preferably, the thickness of the first skin layer is between 20 and 50% of the thickness of the second skin layer. It is also possible that the composition of the first skin layer is different form the composition of the second skin layer.

Different aspects in a product lifecycle may require different qualities and properties for the facestocks and labels. When used, a label comprising a facestock may need to be durable and may need to have a good conformability and clarity. The printability to the label surface may need to be good. In labelling, the stiffness of the facestock in the machine direction may facilitate the labelling, where a label comprising a facestock may need to be detached from a liner. The manufacturing of a facestock may require a chemical composition together with the structure of the facestock to be optimized, as the label may need to be die cut, while the manufacturing method may need to be cost effective and environmentally friendly. To obtain these quite different objectives, the manufacturing method operating parameters may be selected according to the chemical composition and the structure of the layers to produce the facestock. The manufacturing method for the facestock may therefore comprise a combination of operating parameters which, when selected in accordance to the chemical composition and the structure of the layers, may produce a facestock as described above.

From the optical point of view, high transparency of the labels may be preferred. Transparent (clear) labels are substantially transparent to visible light. Transparent no-label look appearance of the label is advantageous, for example, in applications where the objects beneath the label, i.e. the surface of a bottle, should be visible through the label. The haze level of a facestock layer should be lower than 35%, preferably equal to or lower than 25% or lower than 10%, when measured according to the standard ASTM D1003.

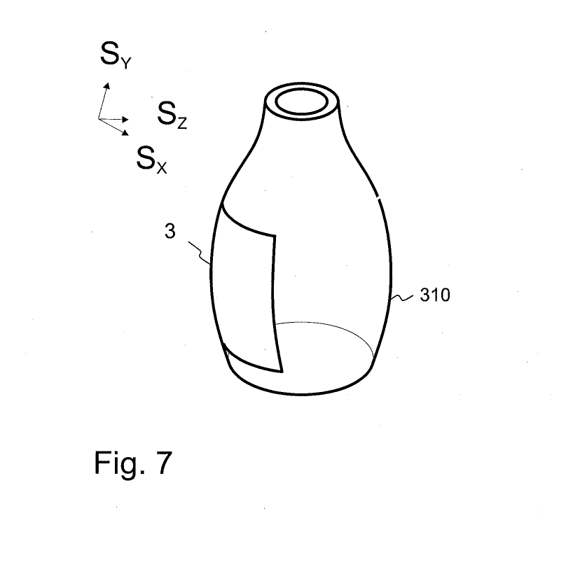

Preferably, the labels are also conformable. In other words, the label can conform smoothly and without wrinkles to the contour of the item even when this is curved in two-dimensions. Referring to FIG. 7 a conformable label 3 attached to the surface of an item 310, such as a bottle, is presented. The facestock of a label 3 has preferably machine direction orientation in direction S_{X}, i.e. direction of the machine direction orientation of the facestock is around the circumference of the bottle.

To obtain a conformable label, also conformable facestock for the label should be provided. FIGS. 5 and 6 present conformability of a multilayer facestock structure. In the conformable facestock, which is rigid in the machine direction Sₓ, the facestock layers preferably comprise different chemical compositions. The facestock is also preferably machine direction oriented in direction Sₓ. Further, by selecting the layer thickness D5, D6 and D7 in each layer according to the used chemical composition, an improved tensile modulus may be obtained. For example, an asymmetric facestock structure presented in FIG. 6 may be preferred. The tensile modulus may be improved further by selecting the operating parameter in the processing method when manufacturing the machine direction oriented facestock.

It may also be preferred to have a facestock structure and a composition which can minimize or eliminate migration of the components from the adhesive layer into the print layer. The multilayer facestock structure having a specific core layer composition, as presented above, may be beneficial in providing a barrier for the migration of adhesive components. Preferably the facestock comprises a propylene homopolymer in the core layer. Preferably the content of propylene homopolymer is higher than the content of polyethylene. For example, the ratio of propylene homopolymer to polyethylene in the core layer is at least 2:1, preferably at least 5:1 or at least 10:1. The propylene homopolymer may also be advantageous in avoiding distortion of the film.

The multilayer facestock is suitable for using with different adhesives. Suitable adhesives include, for example, pressure-sensitive adhesives (PSA), activatable adhesives, hot melt adhesives. Pressure-sensitive adhesives, such as acrylic based adhesives and a natural or synthetic rubber containing elastomers are preferred. During producing a label laminate the adhesive layer may be directly applied onto the facestock on the surface of the second skin layer opposite the core layer, or the adhesive may be applied onto the second surface of the core layer. Alternatively, the adhesive may be applied onto the release liner and subsequently transferred to the facestock when the liner and facestock are combined. When the release liner is removed to expose the adhesive, the adhesive remains joined to the facestock and provides an adhesive surface capable of adhering the facestock to the surface of an article during labelling. If the adhesive is activatable, there may be no need for the release liner. The adhesive may be activated by heat or by another energy source, for example UV.

The multilayer facestocks can be made by co-extrusion, coating, or any other laminating process. In co-extrusion the layers of the multilayer structure are formed simultaneously by using a suitable co-extrusion die. The layers are adhered to each other to provide a unitary co-extrudate. The multilayer films may be co-extruded through blown film extrusion technology. Alternatively, the films may be cast, i.e. produced by cast extrusion technology.

The extruded multilayer facestock is subsequently machine direction oriented under uniaxial stress in order to provide orientation of the polymer chains in the direction of pull. The machine direction (MD) refers to the running direction of the facestock during the manufacturing. The uniaxial stretching of the film in machine direction is so called machine direction orienting (MDO). The stretching allows, for example, the reduction in total facestock film thickness without losing the mechanical properties required for a facestock of a label. During MDO the facestock film is heated to an orientation temperature. Preferably, the orientation temperature is above the glass transition temperature T_{g} of the polymer and below the melting temperature of the polymer Tₘ. The orientation temperature may be e.g. between 110 and 140° C. The heating is preferably performed utilizing multiple heating rollers. Heated film is fed into a drawing section, which includes draw rolls with different rolling speeds. The rolling speed is adjusted so that the predetermined draw ratio of the film is achieved. The stretched film enters the annealing section, which allows stress relaxation of the oriented film by keeping the film at an elevated temperature for a period of time. Finally, the film is cooled through a cooling section to ambient temperature. Thanks to the annealing or heat-setting good thermal stability and non-shrinkage performance of the machine direction oriented film is achieved.

The ratio of total film thickness before and after stretching is called the “draw ratio”. The draw ratio of the facestock film may be between 4:1 and 10:1, or between 5:1 and 10:1, preferably between 6:1 and 8:1, for example 7:1. When stretching the facestock, the thickness of the facestock may diminish in the same ratio as the facestock stretches or elongates. For example, a facestock may have a thickness of 350 micrometers before machine direction orientation (MDO), and is stretched by a draw ratio of 7:1. After the machine direction orientation the facestock may therefore have a seven fold diminished thickness of 50 micrometers.

According to at least some/all embodiments the film has non-shrinkage performance. In addition, the film has good thermal stability. The film may have a shrinkage less than 5%, preferably less than 3%, or more preferably less than 1% at temperatures up to 50 degrees C. For example, the annealed film has a shrinkage less than 5% or even less than 1% at an elevated temperature of 50 degrees C. The film has non-shrinking performance at least in machine direction (MD) of the film. Preferably, the film has non-shrinking performance also in transverse direction (TD) of the film i.e. perpendicular to the machine direction. Overall shrinkage of the film may be between 0.5 and 5%, or between 0.5 and 1% at 50° C.

For the person skilled in the art, it will be clear that modifications and variations of the devices according to the present invention are perceivable. The drawings are schematic. The particular embodiments described above with reference to the accompanying drawings are illustrative only and not meant to limit the scope of the invention, which is defined by the appended claims.

1. A machine direction oriented multilayer facestock for labels, the facestock comprising:
a core layer having a first surface and a second surface, and a first skin layer adjoined to the first surface of the core layer, the first skin layer comprising:
linear low density polyethylene and cyclic olefin copolymer(s), and wherein the facestock is annealed.

2. The machine direction oriented multilayer facestock according to claim 1, wherein the linear low density polyethylene is Ziegler-Natta catalysed.

3. The machine direction oriented multilayer facestock according to claim 1, wherein the first skin layer comprises between 10 and 90 wt. % linear low density polyethylene and between 10 and 70 wt. % cyclic olefin copolymer(s).

4. The machine direction oriented multilayer facestock according to claim 1, wherein the core layer comprises:
at least one of the following: propylene homopolymer, propylene block-copolymer and propylene random copolymer; and
at least one of the following polyolefin elastomer and polyolefin plastomer.

5. The machine direction oriented multilayer facestock according to claim 4, wherein the polyolefin plastomer and polyolefin elastomer are based on copolymers of ethylene or propylene with hexene, octene or butylene.

6. The machine direction oriented multilayer facestock according to claim 5, wherein the core layer further includes low density polyethylene.

7. The machine direction oriented multilayer facestock according to claim 1, further comprising:
a second skin layer adjoined to the second surface of the core layer.

8. A use of a machine direction oriented multilayer facestock according to claim 1 for self-adhesive labels.

9. A self-adhesive label, comprising:
an adhesive layer and a machine direction oriented multilayer facestock comprising at least a core layer having a first surface and a second surface, a first skin layer adjoined to the first surface of the core layer and the adhesive layer adjoined to the second surface of the core layer, said first skin layer comprising:
linear low density polyethylene and cyclic olefin copolymer(s), and wherein the facestock is annealed.

10. The self-adhesive label according to claim 9, wherein the polyethylene is linear low density polyethylene.

11. The self-adhesive label according to claim 9, wherein the first skin layer comprises between 10 and 90 wt. % linear low density polyethylene and between 10 and 70 wt. % cyclic olefin copolymer(s).

12. The self-adhesive label according to claim 9, wherein the core layer comprises:
at least one of the following: propylene homopolymer, propylene block-copolymer and propylene random copolymer; and
at least one of the following polyolefin elastomer and polyolefin plastomer.

13. The self-adhesive label according to claim 12, wherein the polyolefin plastomer and polyolefin elastomer are based on copolymers of ethylene or propylene with hexene, octene or butylene.

14. The self-adhesive label according to claim 10, wherein the facestock further comprise a second skin layer adjoined to the second surface of the core layer.

15. A combination of an item and a label, wherein the label comprises an adhesive layer and a machine direction oriented multilayer facestock, the facestock comprising at least a core layer having a first surface and a second surface, a first skin layer adjoined to the first surface of the core layer and the adhesive layer adjoined to the second surface of the core layer, said first skin layer comprising
linear low density polyethylene and cyclic olefin copolymer(s), and wherein the facestock is annealed.
